(19) United States
(12) Patent Application Publication
(10) Pub. No.: US 2023/0331911 A1
(43) Pub. Date: Oct. 19, 2023

(54) Water-Based Pigment Preparations, Production And Use Of Same

(71) Applicant: Clariant International Ltd, Muttenz (CH)

(72) Inventors: Benjamin SCHEINHARDT, Frankfurt (DE); Dietmar BECk, Frankfurt am Main (DE); Dorothee GABEL, Wiesbaden (DE); Felix HÖVELMANN, Mühldorf (DE); Rainer KUPFER, Hattersheim (DE)

(73) Assignee: Clariant International Ltd, Muttenz (CH)

(21) Appl. No.: 17/425,258

(22) PCT Filed: Jan. 20, 2020
(86) PCT No.: PCT/EP2020/051262

§ 371 Date: Jul. 22, 2021

(30) Foreign Application Priority Data
Jan. 23, 2019 (DE) 10 2019 200 789.9

(51) Int. Cl. C08G 65/26; C09D 17/00; C09D 7/45; C09D 11/102; C09D 11/037; C09D 171/02; C09D 11/36; C09D 11/322

(52) U.S. Cl. CPC C08G 65/2609; C09D 7/45; C09D 11/037; C09D 11/102; C09D 11/322; C09D 11/36; C09D 17/001; C09D 171/02; C08G 2650/30

(57) ABSTRACT

The present invention relates to aqueous pigment preparations, comprising
(A) at least one organic and/or inorganic pigment and/or filler
(B) at least one dispersant of the formula (I) or (II), or mixtures of dispersants of the formulas (I) and (II),

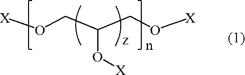

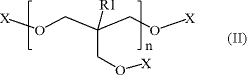

where
   n is an integer greater than or equal to 1, preferably 1 to 5, more preferably 1 to 2,
   z is an integer greater than or equal to 1, preferably 1 to 10, more preferably 1 to 4,
   R1 is an aliphatic, linear or branched hydrocarbon radical having 1 to 10 carbon atoms or a hydrogen atom or the structural unit -O-X or the structural unit —CH₂—O—X,
   and structural unit X corresponds to the formula (III) 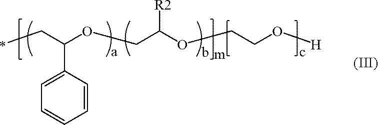
   in which
      a is an integer from 1 to 10,
      b is an integer from 0 to 10,
      c is an integer from 1 to 50,
      m is 1 or 2,
      and R2 is an aliphatic, linear or branched hydrocarbon radical having 1 to 10 carbon atoms,
(C) optionally wetting agents,
(D) optionally further surfactants and/or dispersants,
(E) optionally one or more organic solvents and/or one or more hydrotropic substances and/or mixtures thereof,
(F) optionally further additives customary for the production of aqueous pigment dispersions, and
(G) water.

The present invention provides water-based pigment preparations/pigment dispersions, processes for the production thereof, and for the use thereof for coloring natural and synthetic materials of all kinds, in particular coating materials, coatings, lacquers, paints, glazes, varnishes, wood protection systems, insulating materials, for example glass wool, inks for writing utensils, for example colored pencil leads, fibertip pens, fineliners, felt pens, gel rollers, text or whiteboard markers, and inkjet processes, and also electrophotographic toners and developers, for example one- or two-component powder toners, magnetic toners, liquid toners, latex toners, polymerization toners, and also specialty toners.

Aqueous pigment preparations are liquid mixtures of substances in which the pigment is present in finely divided form in an aqueous medium and which are used as colorants for coloring a wide variety of systems.

Many uses require pigment preparations having the smallest possible particle sizes and the narrowest possible particle size distribution range. This applies for example to use in lacquers, glazes and varnishes, such as those used for coating wood, in which high transparency is often required. For use in inks for writing utensils, for example fineliners, felt pens, gel rollers, text or whiteboard markers, for inkjet processes, and also toners for electrophotographic printing processes, high particle fineness is essential in order to avoid, for example, blockage of the nozzles or nibs.

In addition to pigment preparations, dyes are classically also used in these fields of use. However, not only do many pigments have toxicological and ecotoxicological advantages over conventional dyes, they also have technical advantages, such as better light and weather fastness and better bleeding resistance, that are achievable with dyes only with great difficulty or not at all. In many fields, the use of pigment preparations instead of dyes is therefore desirable. On the other hand, the use-related and coloristic properties of dyes, for example high transparency, color strength, purity, and brilliance, are attainable with pigments only with difficulty and generally require the highest possible degree of dispersion, i.e. smallest possible particle sizes. For the uses mentioned above, the particle sizes must typically be smaller than 1 µm, wherein preferably 95% of the particles must be smaller than 500 nm. If pigment preparations are to be used instead of dyes, the relatively high color strength of dyes means moreover that the pigment content in the pigment preparations needs to be as high as possible.

For the dispersion of pigments, surface-active substances, such as wetting agents and dispersing agents, are normally employed, which physically stabilize the pigment particles in their finely divided form in the continuous medium and have significant influence on the properties of a pigment preparation. The achievement and stabilization of pigment particles in the abovementioned size range requires dispersing agents having very high dispersing power. Moreover, the achievement of particle sizes smaller than 500 nm alongside a rheology profile that, even after storage, meets the requirements of the uses described above, in particular a viscosity of less than 1.0 Pa*s, while keeping the pigment content as high as possible, represents a major challenge to the dispersing agents employed.

Easy and efficient incorporation of the pigment preparation into the system to be colored without flocculation or reagglomeration of the pigment particles is essential. The compatibility with the application medium is significantly influenced here by the dispersing agents employed. For the uses described above, compatibility of the aqueous pigment preparation with various organic solvents, in particular with alcohols of varying chain length, preferably ethanol, is required, i.e. crystal growth or crystal phase transitions and an agglomeration or flocculation of the particles must be effectively prevented. In accordance with the known particle stabilization mechanisms, the dispersing agents employed must therefore bring about good steric stabilization of the dispersed particles in these application media.

For the uses described above, the pigment preparation must also be stable under shear, elevated temperature, and also variations in pressure, for example for the use in inks for inkjet processes, which flow through the nozzles at high speed during printing, in lacquers, for example for spray applications, or during degassing/deaeration.

In addition, aqueous pigment preparations and formulation components thereof must not otherwise interact adversely with one another or with the application medium, for example they must not cause any unwanted breakdown of the biocides used. This applies in particular also to by-products and/or unreacted reactants present in the formulation components.

The supply of aqueous pigment preparations for the uses mentioned above that, besides the high technical requirements, particularly in respect of particle size distribution, compatibility and miscibility with the respective application medium, coloristic properties, pigment content, rheology profile, stability, and tendency to foaming, also meets the regulatory requirements, for example in respect of the toxicological and ecotoxicological profile, is a growing challenge in industry.

The reason for this is, in particular, that progressive tightening of chemical legislation and also the issuing of eco-labeling, for example the Blue Angel or the European eco-labels, have increasingly made the use of customary formulation components for pigment preparations no longer possible in some fields of use or possible only to a limited degree. This relates in particular also to wetting agents and dispersants. For example, alkylphenol ethoxylates (APEOs) are now strictly regulated on account of the bioaccumulative and hormonally active degradation products and are proscribed for many uses. Although the use of tristyrylphenol ethoxylates (TSPEOs) is still possible, the disadvantageous ecotoxicological profile has given rise to a strong trend in industry away from use of these raw materials. The use of novolak- or bisphenol A-based dispersants used in the past is gradually being restricted for the same reasons. Moreover, the use of oxalkylated reaction products based on primary and secondary amines as dispersants is for some uses questionable for regulatory and use-related reasons and accordingly possible only to a limited extent.

Aqueous pigment preparations based on different polymeric dispersing agents are described in the prior art.

EP 1 078 946 discloses aqueous pigment pastes based on block-copolymeric, styrene-oxide-containing polyalkylene oxides as pigment wetting agents.

EP 1 805 270 describes water-based pigment preparations based on oligoesters.

DE 10 2006 002 800 discloses aqueous pigment preparations based on copolymers of styrene oxide, alkylene oxides, and dihydric or polyhydric amines and alcohols. The pigment preparations described here do not however have the property profile needed, for example low particle sizes in the nano range or high transparency, for the uses mentioned above. The necessary compatibility of the pigment preparations with organic solvents such as alcohols has also not been identified here. Moreover, regulatory and use-related requirements mean that the use of dispersants based on amines is often not desirable in the uses mentioned above, which places severe limitations on the pigment preparations described in DE 10 2006 002 800. Although the disclosed viscosities of the pigment preparations are within the desired range of < 1 Pa*s, the pigment contents described therein and the associated color strengths of the pigment preparations are relatively low, and the rheology and also the storage stability of the pigment preparations at the pigment contents needed for the uses mentioned above is not described.

EP 2 147 066 describes aqueous pigment preparations based on nonionic copolymers that are produced using macromonomers from polyethylene/polypropylene glycol mono(meth)acrylate esters.

The aqueous pigment preparations described in the prior art often have particle sizes and particle size distribution ranges that are too large for them to be employable for the uses described above. In addition, their rheology profile and storage stability are often inadequate at the required pigment contents. Their color strength and compatibility with the application systems are also in need of substantial further improvement.

No aqueous pigment preparations have thus far been described that meet all the conditions for the uses described above without having to accept drawbacks.

It was the object of the present invention to provide aqueous pigment preparations in which 95% of the particles are preferably smaller than 500 nm in size. These should also be free of alkylphenol derivatives, tristyrylphenol derivatives, novolak derivatives, and bisphenol A derivatives and also of primary and secondary amines, and should readily undergo dilution with alcohols of varying chain length without coagulation or flocculation. In addition, the preparations should have the highest possible transparency and color strength and lowest possible tendency to foaming. The aqueous preparations should be storage stable, i.e. the properties described above should remain stable even during storage for a relatively long period. The preparations must also be shear stable, i.e. the color properties or color strength must not change significantly under shear.

This object was surprisingly achieved by dispersing the pigment with special copolymers of trihydric or polyhydric polyols, styrene oxide, and alkylene oxides that are defined hereinbelow. By virtue of the at least trihydric starter molecules, these polymers have star-branched or dendrimer-like structures having a more hydrophobic core and a more hydrophilic periphery. The use of different copolymers based on different starter molecules and having compositions or block sequences different than those mentioned affords aqueous pigment preparations that do not have the full property profile mentioned above, particularly in respect of the desired particle size distribution, coloristic properties, compatibility, viscosity, and also stability.

The invention therefore provides aqueous pigment preparations, comprising
(A) at least one organic and/or inorganic pigment and/or filler
(B) at least one dispersant of the formula (I) or (II), or mixtures of dispersants of the formulas (I) and (II),

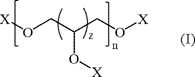

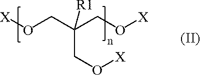

where
   n is an integer greater than or equal to 1, preferably 1 to 5, more preferably 1 to 2,
   z is an integer greater than or equal to 1, preferably 1 to 10, more preferably 1 to 4,
   R1 is an aliphatic, linear or branched hydrocarbon radical having 1 to 10 carbon atoms or a hydrogen atom or the structural unit —O—X or the structural unit —CH₂—O—X,
   and structural unit X corresponds to the formula (III) 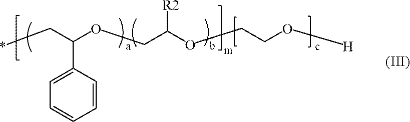
   in which
      a is an integer from 1 to 10,
      b is an integer from 0 to 10,
      c is an integer from 1 to 50,
      m is 1 or 2; and
      R2 is an aliphatic, linear or branched hydrocarbon radical having 1 to 10 carbon atoms,
   wherein 95% of the particles in component (A) have a particle size of less than 1 µm, preferably less than 500 nm.

Furthermore, the pigment preparation of the invention may also comprise the following further additives:
(C) optionally wetting agents,
(D) optionally further surfactants and/or dispersants,
(E) optionally one or more organic solvents and/or one or more hydrotropic substances and/or mixtures thereof,
(F) optionally further additives customary for the production of aqueous pigment dispersions, and
(G) water.

Preferred pigment preparations comprise 5% to 80% by weight, preferably 10% to 70% by weight, more preferably 30% to 70% by weight, of component (A). Preferred pigment preparations comprise 0.1% to 30% by weight, preferably 2% to 20% by weight, more preferably 5% to 15% by weight, of component (B).

Particularly preferred pigment preparations comprise the components in the following contents:
(A) 5% to 80% by weight, in particular 10% to 70% by weight,
(B) 0.1% to 30% by weight, in particular 2% to 20% by weight,
(C) 0% to 10% by weight, in particular 0.1% to 5% by weight,
(D) 0% to 20% by weight, in particular 1% to 10% by weight,
(E) 0% to 30% by weight, in particular 5% to 20% by weight,
(F) 0% to 20% by weight, in particular 0.1% to 5% by weight,
(G) remainder water,
in each case based on the total weight (100% by weight) of the pigment preparation.

Where the pigment preparation of the invention comprises one or more of components (C), (D), (E), and (F), the minimum concentration of said components is, independently of one another, preferably at least 0.01% by weight, in particular at least 0.1% by weight, based on the total weight of the pigment preparation.

Component (A) of the pigment preparation of the invention is a finely divided, organic or inorganic pigment or a filler or a mixture of different organic and/or inorganic pigments and/or fillers. Component (A) may also be a dye that in certain solvents is soluble and in other solvents has pigment character. The pigments may be used either in the form of the dry powder or as water-wet press cakes.

Suitable organic pigments include monoazo pigments, disazo pigments, laked azo pigments, β-naphthol pigments, naphthol AS pigments, benzimidazolone pigments, disazo condensation pigments, azo metal complex pigments, and polycyclic pigments, for example phthalocyanine pigments, quinacridone pigments, perylene pigments, perinone pigments, thioindigo pigments, anthanthrone pigments, anthraquinone pigments, flavanthrone pigments, indanthrone pigments, isoviolanthrone pigments, pyranthrone pigments, dioxazine pigments, quinophthalone pigments, isoindolinone pigments, isoindoline pigments, and diketopyrrolopyrrole pigments or carbon blacks.

A selection of particularly preferred organic pigments that can be mentioned by way of example includes carbon black pigments, for example gas carbon blacks or furnace carbon blacks; monoazo pigments and disazo pigments, in particular the Color Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Yellow 219, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol pigments and naphthol AS pigments, in particular the Color Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo pigments and metal complex pigments, in particular the Color Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, in particular the Color Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone pigments and isoindoline pigments, in particular the Color Index pigments Pigment Yellow 139 or Pigment Yellow 173; phthalocyanine pigments, in particular the Color Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone pigments, anthraquinone pigments, quinacridone pigments, dioxazine pigments, indanthrone pigments, perylene pigments, perinone pigments, and thioindigo pigments, in particular the Color Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, in particular the Color Index pigments Pigment Red 169, Pigment Blue 56 or Pigment Blue 61; diketopyrrolopyrrole pigments, in particular the Color Index pigments Pigment Red 254, Pigment Red 255, Pigment Red 264, Pigment Red 270, Pigment Red 272, Pigment Orange 71, Pigment Orange 73, Pigment Orange 81.

Also suitable are laked dyes such as Ca, Mg, and Al lakes of dyes containing sulfonic acid and/or carboxylic acid groups.

Examples of suitable inorganic pigments are titanium dioxides, zinc sulfides, zinc oxides, iron oxides, magnetites, manganese iron oxides, chromium oxides, ultramarine, nickel antimony titanium oxides or chromium antimony titanium oxides, manganese titanium rutiles, cobalt oxides, mixed oxides of cobalt and aluminum, rutile mixed-phase pigments, sulfides of the rare earths, spinels of cobalt with nickel and zinc, spinels based on iron and chromium with copper, zinc, and manganese, bismuth vanadates, and extender pigments. More particularly, the Color Index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17, Pigment Black 11, Pigment Black 33, and Pigment White 6 are used. Preference is also frequently given to using mixtures of inorganic pigments. Mixtures of organic with inorganic pigments are likewise frequently used.

Examples of suitable fillers are finely divided ores, minerals, and sparingly soluble or insoluble salts, for example carbonates, calcium carbonate, dolomite, silicon dioxide, quartz, cristobalite, kieselguhr, silicates, aluminosilicates, silicas, talc, kaolin, mica, feldspar, and also barium sulfate. Preference is also frequently given to using mixtures of fillers. Mixtures of organic and/or inorganic pigments with fillers are likewise frequently used. Formulations comprising exclusively one or more fillers are used for example for blending pigment preparations to adjust the desired property profile, for example the pigment content, rheology, density or compatibility.

Structural units (I) and (II) of component (B) are reaction products of alkoxylatable trihydric or polyhydric polyols, preferably diglycerol, erythritol, glycerol, pentaerythritol, polyglycerols, sorbitol, trimethylolpropane or xylitol, more preferably glycerol and pentaerythritol.

In formula (III) the asterisk indicates the position of attachment of this radical to the remainder of the molecule (formula I or II). Starting from this bond, it is necessary that the structural unit having the stoichiometric index m is always present in front of the structural unit having the stoichiometric index c, i.e. that the polyol starter always undergoes reaction first with styrene oxide and/or an alkylene oxide other than ethylene oxide, before undergoing further polymerization with ethylene oxide. The blocks having the stoichiometric indices a and b inside the brackets having the stoichiometric index m may on the other hand be in a random or blockwise arrangement.

Used as component (C) are for example cationic, anionic, amphoteric or nonionogenic compounds that promote pigment wetting (wetting agents).

Serving as component (D) of the pigment preparations of the invention are customary dispersants and surfactants suitable for the production of aqueous pigment dispersions, or mixtures of such substances. Anionic, cationic, amphoteric or nonionic surface-active compounds are normally used for this purpose. Of particularly proven utility among these are dispersants having one or more medium- or long-chain hydrocarbon chains, including in some cases those having aromatic ring groups. Only a selection of the large number of compounds shall be listed here; the applicability of the preparations of the invention is not however restricted to these examples. Examples are alkyl sulfates, for example lauryl sulfate, stearyl sulfate or octadecyl sulfate, primary alkyl sulfonates, for example dodecyl sulfonate, and secondary alkyl sulfonates, in particular the C₁₃-C₁₇ alkanesulfonate sodium salt, alkyl phosphates, alkylbenzene sulfonates, for example dodecylbenzenesulfonic acid, and also all salts of said compounds. Also suitable is soya lecithin, or condensation products of fatty acid and taurine or hydroxyethanesulfonic acid are used, likewise alkoxylation products of castor oil colophonium esters, fatty alcohols, fatty amines, fatty acids, and fatty acid amides; these alkoxylation products can similarly be furnished with ionic end groups, for example in the form of sulfosuccinic hemiesters or else in the form of sulfonic, sulfuric, and phosphoric esters, and also the salts, the sulfonates, sulfates or phosphates thereof. Also suitable are nonionic or anionically modified copolymers produced using macromonomers from polyethylene/polypropylene glycol mono(meth)acrylate esters, in similar manner also nonionic or anionically modified block-copolymeric, styrene oxide-containing polyalkylene oxides.

Component (E) corresponds to organic solvents or hydrotropic substances. These may for example be the following compounds or a mixture thereof: Mono- or polyhydric alcohols, the ethers and esters thereof, for example alkanols, in particular those having 1 to 4 carbon atoms, for example methanol, ethanol, propanol, isopropanol, butanol, isobutanol; dihydric or trihydric alcohols, in particular those having 2 to 5 carbon atoms, for example ethylene glycol, propylene glycol, propane-1,3-diol, butane-1,4-diol, pentane-1,5-diol, hexane-1,6-diol, hexane-1,2,6-triol, glycerol, diethylene glycol, dipropylene glycol, triethylene glycol, polyethylene glycol, tripropylene glycol, polypropylene glycol; lower alkyl ethers of polyhydric alcohols, for example ethylene glycol monomethyl, monoethyl or monobutyl ether, triethylene glycol monomethyl or monoethyl ether; ketones and ketone alcohols, for example acetone, methyl ethyl ketone, diethyl ketone, methyl isobutyl ketone, methyl pentyl ketone, cyclopentanone, cyclohexanone, diacetone alcohol; copolymers of ethylene glycol and propylene glycol.

Used as component (F) are for example thickeners, preservatives, viscosity stabilizers, and grinding aids. Further customary additives may be antisettling agents, light stabilizers, antioxidants, defoamers/degassing agents/deaeration agents, foam-reducing agents, anticaking agents, and additives that have a beneficial effect on viscosity and rheology. Suitable agents for regulating viscosity are for example polyvinyl alcohol and cellulose derivatives. Water-soluble natural or synthetic resins and polymers may also be considered as film formers and binders to increase adhesive strength and abrasion resistance. The pH regulators used are organic or inorganic bases and acids. Preferred organic bases are amines, for example ethanolamine, diethanolamine, triethanolamine, N,N-dimethylethanolamine, diisopropylamine, aminomethylpropanol or dimethylaminomethylpropanol. Preferred inorganic bases are sodium hydroxide, potassium hydroxide, lithium hydroxide or ammonia. Component (F) may also correspond to fats and oils of plant and animal origin, for example beef tallow, palm kernel fat, coconut fat, rapeseed oil, sunflower oil, linseed oil, palm oil, soya oil, groundnut oil and whale oil, cottonseed oil, corn oil, poppyseed oil, olive oil, castor oil, colza oil, safflower oil, soybean oil, thistle oil, sunflower oil, herring oil, sardine oil. Common additives are also the saturated and unsaturated higher fatty acids, for example palmitic acid, cyprylic acid, capric acid, myristic acid, lauric acid, stearic acid, oleic acid, linoleic acid, linolenic acid, caproic acid, caprylic acid, arachidic acid, behenic acid, palmitoleic acid, gadoleic acid, erucic acid, and ricinoleic acid, and also salts thereof.

Water used for production of the pigment preparations, component (G), is preferably used in the form of distilled or demineralized water. It is also possible to use drinking water (tap water) and/or water of natural origin.

The pigment preparations are characterized in that the particle sizes of component (A) are less than 1 µm, wherein preferably 95% and more preferably 99% of the pigment particles have a particle size of less than 1 µm, in particular less than 500 nm. The average particle size is less than 200 nm and preferably less than 150 nm.

The pigment preparations have high transparency and color strength and have a low tendency to foaming. They have a viscosity of less than 1.0 Pa*s, preferably less than 0.7 Pa*s, and more preferably less than 0.5 Pa*s. The pigment preparations are miscible with alcohols of varying chain length, preferably ethanol, in any desired proportions, without coagulation or flocculation of the pigment particles. The pigment preparations have good storage stability and good shear stability.

The pigment preparations of the invention are also free of alkylphenol derivatives, tristyrylphenol derivatives, novolak derivatives, and bisphenol A derivatives, and also of primary and secondary amines.

The present invention also provides a process for producing such pigment preparations, characterized in that component (A) in the form of powder, granules or aqueous press cakes is dispersed in the presence of water (G) and also components (B) and optionally (C), (D), (E), and (F), and then admixed optionally with water (G) and also optionally with one or more of components (C), (D), (E), and (F), and the resulting aqueous pigment dispersion is optionally diluted with water (G).

In this process, the pigment and the dispersing agent of the formula (I) or (II) or mixtures of dispersants of the formulas (I) and (II) are finely dispersed or finely divided in the presence of water using a dispersing unit or combinations of different dispersing units, preferably a stirred ball mill operated at a peripheral stirrer speed of over 10 m/s and under the action of non-metallic grinding media having a diameter of less than or equal to 1.2 mm, preferably less than or equal to 0.8 mm. The remaining additives may be present during the fine dispersion and/or added subsequently.

The present invention also provides for the use of the pigment preparations of the invention as colorants for pigmentation and coloring of natural and synthetic materials of all kinds, in particular of aqueous coating materials, coatings, emulsion/gloss paints (dispersion coatings), water-thinnable lacquers, glazes, varnishes, and wood protection systems, printing inks, here by way of example textile, flexographic, decorative, or gravure printing inks, electrophotographic toners and developers, for example one- or two-component powder toners (also known as one- or two-component developers), magnetic toners, liquid toners, latex toners, polymerization toners, and also specialty toners, inks, preferably inkjet inks, for example water-based or non-water-based (“solvent-based”) inks, microemulsion inks, UV-curable inks, and also in those inks that function according to the hot-melt process, inks for writing utensils, for example colored pencil leads, fibertip pens, fineliners, felt pens, gel rollers, text or whiteboard markers, and also insulating materials, for example glass wool.

The pigment preparations of the invention are also suitable for coloring macromolecular materials of all kinds, e.g. natural and synthetic fiber materials. Further uses are the coloring of sausage casings, seeds, fertilizers, glass, in particular glass bottles, plaster, cement, wood stains, waxes, paraffins, drawing inks, pastes for ballpoint pens, chalks, washing and cleaning agents, shoe-care agents, latex products, abrasives, in spin dyeing of viscose, and also for coloring plastics and high-molecular-weight materials of all kinds. High-molecular-weight organic materials are for example cellulose ethers/esters, for example ethylcellulose, nitrocellulose, cellulose acetate or cellulose butyrate, natural resins or synthetic resins, such as polymerization resins or condensation resins, for example aminoplasts, in particular urea- and melamine-formaldehyde resins, alkyd resins, acrylic resins, phenoplasts, polycarbonates, polyolefins, such as polystyrene, polyvinyl chloride, polyethylene, polypropylene, polyacrylonitrile, polyacrylic esters, polyamides, polyurethanes or polyesters, rubber, casein, latexes, silicone, silicone resins, individually or as a mixture.

In addition, the pigment preparations of the invention can also be used as colorants for color filters for flat-panel displays, both for additive and for subtractive color generation, also for photoresists, and as colorants for electronic inks (“e-inks”) or electronic paper (“e-paper”).

### EXAMPLES

Examples of the dispersants used in the pigment preparations of the invention are the following compounds obtained by alkoxylation of the corresponding polyols.

| | | |
|---|---|---|
| Sample | Composition | Chemical structure |
| Sample 1 | Pentaerythritol | 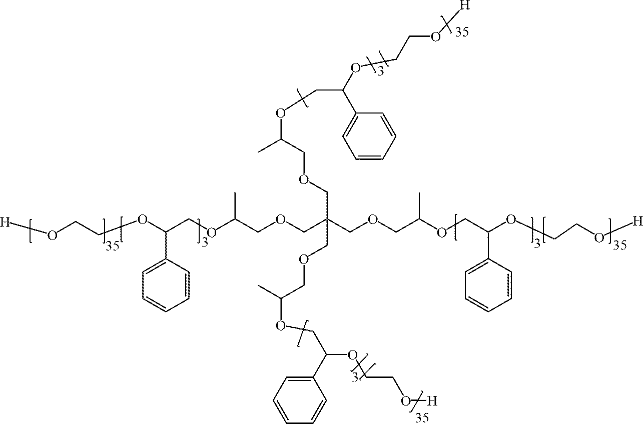 |
| | + 4 mol propylene oxide | |
| | + 12 mol styrene oxide | |
| | + 140 mol ethylene oxide | |

| | | |
|---|---|---|
| Sample 2 | Pentaerythritol | 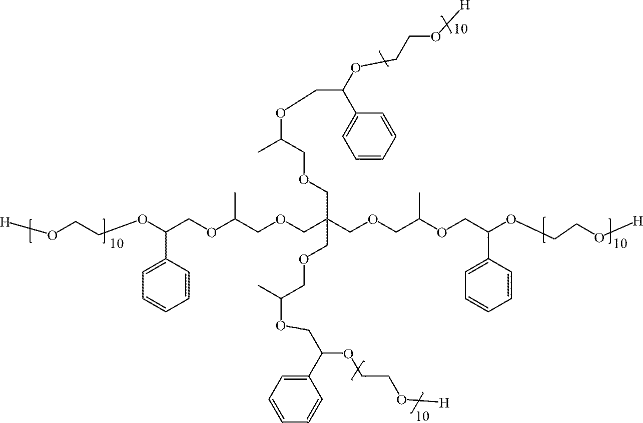 |
| | + 4 mol propylene oxide | |
| | + 4 mol styrene oxide | |
| | + 40 mol ethylene oxide | |
| Sample 3 | Glycerol | 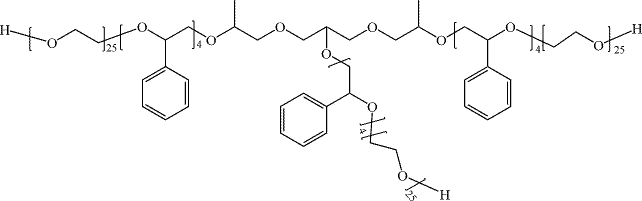 |
| | + 12 mol styrene oxide | |
| | + 75 mol ethylene oxide | |
| Sample 4 | Glycerol | 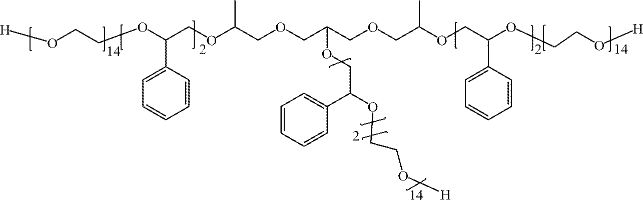 |
| | + 6 mol styrene oxide | |
| | + 42 mol ethylene oxide | |
| Compar ative sample 1 | Ethylenediamine | 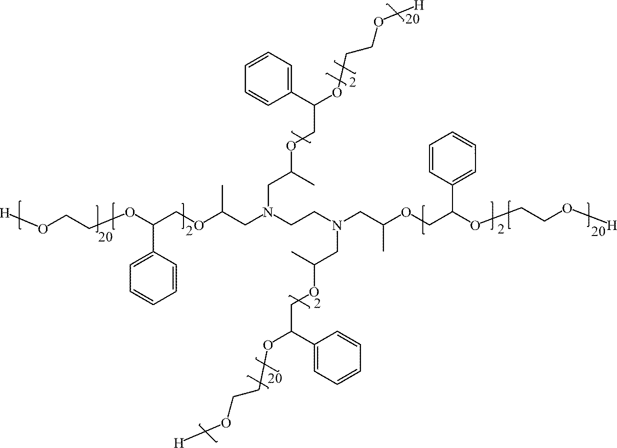 |
| | + 4 mol propylene oxide | |
| | + 8 mol styrene oxide | |
| | + 80 mol ethylene oxide | |

### Production of a Pigment Preparation

The pigment, either in the form of powder, granules or as press cakes, together with the dispersants and the other additives, was converted into a paste in deionized water and then homogenized and predispersed with a dissolver (for example from VMA-Getzmann GmbH, model AE3-M1) or another suitable apparatus. The subsequent fine dispersion was effected with the aid of a bead mill (for example AE3-M1 from VMA-Getzmann GmbH) or another suitable dispersing unit, the grinding being effected with zirconium silicate beads or zirconium oxide beads of size d = 0.4-0.6 mm with cooling, until the desired color strength, color properties, transparency, and particle size distribution were attained. The dispersion was then adjusted to the desired final pigment concentration with deionized water, the grinding media removed, and the pigment preparation isolated.

The pigment preparations described in the examples that follow were produced by the process described above, using the constituents in the amounts specified so as to form 100 parts of the respective pigment preparation. In the examples that follow, parts mean parts by weight.

### Evaluation of a Pigment Preparation

Color strength and hue were determined in accordance with DIN 55986. For the determination of compatibility by the rub-out test, the emulsion paint or the lacquer, after mixing with the pigment dispersion, was applied to a paint card. The lower part of the paint card was then subsequently rubbed with a finger. An intolerance was present if the subsequently rubbed area was more strongly colored than the adjoining area that was not subsequently treated (the rub-out test is described in DE 2 638 946). The transparency of the pigment preparations was determined in an aqueous acrylate varnish by drawing onto a paint card having black contrast bars.

The viscosity was determined at 20° C. with a cone-plate viscometer (MCR 72) from Anton Paar GmbH (titanium cone: Ø 60 mm, 1°), with the dependence of the viscosity on the shear rate investigated in a range between 0 and 200 s⁻¹. The viscosity was evaluated at a shear rate of 60 s⁻¹.

Particle size distributions were determined using a disk centrifuge (CPS disk centrifuge DC24000 UHR) from CPS Instruments.

To examine the miscibility with ethanol, the pigment preparation was diluted to 1% by weight with water and then ethanol was added gradually in increments of 5% up to a maximum added amount of 50% ethanol. To evaluate the stability, the homogeneity of the mixture was visually assessed after 7 days.

For evaluation of the storage stability of the dispersions, the viscosity was measured immediately after production of the preparations and also after storage for 28 days at 50° C. In addition, the color strength of the sample thus stored was determined against a sample stored at room temperature. Additionally, the homogeneity and the sedimentation profile of the stored sample were assessed by determination of the sediment that formed and of the supernatant.

The pigment preparations described in the examples that follow were produced by the process described above, using the constituents shown below in the amounts specified so as to form 100 parts of the respective pigment preparation. In the examples that follow, parts mean parts by weight.

### Example 1

45.0 parts of component (A), C.I. Pigment Red 112
7.0 parts of component (B), dispersant as per sample 1
11.0 parts of component (E), propylene glycol
0.6 parts of component (F), preservative
Remainder component (G), water

The pigment preparation has a consistently high color strength and transparency. The average particle size is < 180 nm and 95% of the particles are smaller than 350 nm. The rub-out test in all cases shows no differences compared with the subsequently rubbed area. The preparation is miscible with ethanol and was found to have good flowability and to be storage stable. The viscosity after production was 0.34 Pa*s. The preparation is shear stable and does not foam.

### Example 2

30.0 parts of component (A), C.I. Pigment Violet 023
8.0 parts of component (B), dispersant as per sample 1
10.0 parts of component (E), propylene glycol
0.6 parts of component (F), preservative
Remainder component (G), water

The pigment preparation has a consistently high color strength and transparency. The average particle size is < 100 nm and 95% of the particles are smaller than 250 nm. The rub-out test in all cases shows no differences compared with the subsequently rubbed area. The preparation is miscible with ethanol and was found to have good flowability and to be storage stable. The viscosity after production was 0.04 Pa*s. The preparation is shear stable and does not foam.

### Example 3

45.0 parts of component (A), C.I. Pigment Red 112
7.0 parts of component (B), dispersant as per sample 2
11.0 parts of component (E), propylene glycol
0.6 parts of component (F), preservative
Remainder component (G), water

The pigment preparation has a consistently high color strength and transparency. The average particle size is < 180 nm and 95% of the particles are smaller than 350 nm. The rub-out test in all cases shows no differences compared with the subsequently rubbed area. The preparation is miscible with ethanol and was found to have good flowability and to be storage stable. The viscosity after production was 0.11 Pa*s. The preparation is shear stable and does not foam.

### Example 4

45.0 parts of component (A), C.I. Pigment Red 112
7.0 parts of component (B), dispersant as per sample 3
11.0 parts of component (E), propylene glycol
0.6 parts of component (F), preservative
Remainder component (G), water

The pigment preparation has a consistently high color strength and transparency. The average particle size is < 180 nm and 95% of the particles are smaller than 350 nm. The rub-out test in all cases shows no differences compared with the subsequently rubbed area. The preparation is miscible with ethanol and was found to have good flowability and to be storage stable. The viscosity after production was 0.68 Pa*s. The preparation is shear stable and does not foam.

### Example 5

40.0 parts of component (A), C.I. Pigment Blue 015:3
8.0 parts of component (B), dispersant as per sample 3
10.0 parts of component (E), propylene glycol
0.6 parts of component (F), preservative
Remainder component (G), water

The pigment preparation has a consistently high color strength and transparency. The average particle size is < 100 nm and 95% of the particles are smaller than 180 nm. The rub-out test in all cases shows no differences compared with the subsequently rubbed area. The preparation is miscible with ethanol and was found to have good flowability and to be storage stable. The viscosity after production was 0.19 Pa*s. The preparation is shear stable and does not foam.

Although the pigment preparations based on C.I. Pigment Blue 015:3 described in DE 10 2006 002 800 have a viscosity within the desired range of < 1 Pa*s, their pigment content is only 30% by weight. In contrast thereto, the pigment content in example 5 shown above is 40% by weight, which corresponds to a > 33% increase in the pigment content while maintaining good storage stability and viscosity.

### Example 6

33.0 parts of component (A), C.I. Pigment Black 007
13.0 parts of component (B), dispersant as per sample 3
1.0 part of component (C), wetting agent
0.8 parts of component (F), preservative
Remainder component (G), water

The pigment preparation has a consistently high color strength and transparency. The average particle size is < 50 nm and 95% of the particles are smaller than 100 nm. The rub-out test in all cases shows no differences compared with the subsequently rubbed area. The preparation is miscible with ethanol and was found to have good flowability and to be storage stable. The viscosity after production was 0.25 Pa*s. The preparation is shear stable and does not foam.

Although the pigment preparation based on C.I. Pigment Black 007 described in DE 10 2006 002 800 has a viscosity within the desired range of < 1 Pa*s, its pigment content is only 25% by weight. In contrast thereto, the pigment content in example 6 shown above is 33% by weight, which corresponds to a 32% increase in the pigment content while maintaining good storage stability and viscosity.

### Example 7

30.0 parts of component (A), C.I. Pigment Violet 023
8.0 parts of component (B), dispersant as per sample 3
10.0 parts of component (E), propylene glycol
0.6 parts of component (F), preservative
Remainder component (G), water

The pigment preparation has a consistently high color strength and transparency. The average particle size is < 100 nm and 95% of the particles are smaller than 250 nm. The rub-out test in all cases shows no differences compared with the subsequently rubbed area. The preparation is miscible with ethanol and was found to have good flowability and to be storage stable. The viscosity after production was 0.03 Pa*s. The preparation is shear stable and does not foam.

### Example 8

45.0 parts of component (A), C.I. Pigment Red 112
7.0 parts of component (B), dispersant as per sample 4
11.0 parts of component (E), propylene glycol
0.6 parts of component (F), preservative
Remainder component (G), water

The pigment preparation has a consistently high color strength and transparency. The average particle size is < 180 nm and 95% of the particles are smaller than 350 nm. The rub-out test in all cases shows no differences compared with the subsequently rubbed area. The preparation is miscible with ethanol and was found to have good flowability and to be storage stable. The viscosity after production was 0.29 Pa*s. The preparation is shear stable and does not foam.

### Example 9

40.0 parts of component (A), C.I. Pigment Blue 015:3
8.0 parts of component (B), dispersant as per sample 4
10.0 parts of component (E), propylene glycol
0.6 parts of component (F), preservative
Remainder component (G), water

The pigment preparation has a consistently high color strength and transparency. The average particle size is < 100 nm and 95% of the particles are smaller than 180 nm. The rub-out test in all cases shows no differences compared with the subsequently rubbed area. The preparation is miscible with ethanol and was found to have good flowability and to be storage stable. The viscosity after production was 0.28 Pa*s. The preparation is shear stable and does not foam.

Although the pigment preparations based on C.I. Pigment Blue 015:3 described in DE 10 2006 002 800 have a viscosity within the desired range of < 1 Pa*s, their pigment content is only 30% by weight. In contrast thereto, the pigment content in example 9 shown above is 40% by weight, which corresponds to a > 33% increase in the pigment content while maintaining good storage stability and viscosity.

### Example 10

33.0 parts of component (A), C.I. Pigment Black 007
13.0 parts of component (B), dispersant as per sample 4
1.0 part of component (C), wetting agent
0.8 parts of component (F), preservative
Remainder component (G), water

The pigment preparation has a consistently high color strength and transparency. The average particle size is < 50 nm and 95% of the particles are smaller than 100 nm. The rub-out test in all cases shows no differences compared with the subsequently rubbed area. The preparation is miscible with ethanol and was found to have good flowability and to be storage stable. The viscosity after production was 0.05 Pa*s. The preparation is shear stable and does not foam.

Although the pigment preparation based on C.I. Pigment Black 007 described in DE 10 2006 002 800 has a viscosity within the desired range of < 1 Pa*s, its pigment content is only 25% by weight. In contrast thereto, the pigment content in example 10 shown above is 33% by weight, which corresponds to a 32% increase in the pigment content while maintaining good storage stability and viscosity.

### Example 11

30.0 parts of component (A), C.I. Pigment Violet 023
8.0 parts of component (B), dispersant as per sample 4
10.0 parts of component (E), propylene glycol
0.6 parts of component (F), preservative
Remainder component (G), water

The pigment preparation has a consistently high color strength and transparency. The average particle size is < 100 nm and 95% of the particles are smaller than 250 nm. The rub-out test in all cases shows no differences compared with the subsequently rubbed area. The preparation is miscible with ethanol and was found to have good flowability and to be storage stable. The viscosity after production was 0.03 Pa*s. The preparation is shear stable and does not foam.

### Comparative Example 1

40.0 parts of component (A), C.I. Pigment Blue 015:3
8.0 parts of component (B), dispersant as per comparative sample 1
10.0 parts of component (E), propylene glycol
0.6 parts of component (F), preservative
Remainder component (G), water

The pigment preparation is neither flowable nor storage stable, since it had set solid after standing for < 1 day. This can be attributed to the employed dispersant having provided inadequate pigment wetting and particle stabilization.

### Comparative Example 2

33.0 parts of component (A), C.I. Pigment Black 007
13.0 parts of component (B), dispersant as per comparative sample 1
1.0 part of component (C), wetting agent
0.8 parts of component (F), preservative
Remainder component (G), water

The pigment preparation has low color strength and transparency. The color strength is only 60% of that in example 6. The rub-out test shows an intolerance in the white dispersion, since the subsequently rubbed area has a higher color strength. The preparation is not storage stable, since the viscosity had after storage for 28 days at 50° C. risen from 0.03 Pa*s to 2.5 Pa*s.

### Comparative Example 3

30.0 parts of component (A), C.I. Pigment Violet 023
8.0 parts of component (B), dispersant as per comparative sample 1
10.0 parts of component (E), propylene glycol
0.6 parts of component (F), preservative
Remainder component (G), water

The pigment preparation has a very low color strength. The color strength is only 90% of that in example 2. The pigment preparation is poorly miscible with ethanol, since clearly visible coagulation or flocculation occurred during addition of ethanol and the pigment had visibly settled after < 1 day.

| Example | C.I. | Pigment content [% by weight] | Color strength | d50 [nm] | d95 [nm] | Compatibility | Miscibility with ethanol | Viscosity [Pa*s] | Storage stability |
|---|---|---|---|---|---|---|---|---|---|
| 1 | Pigment Red 112 | 45 | very good | < 180 | < 350 | no rub out | very good | 0.34 | very good |
| 2 | Pigment Violet 023 | 30 | very good | < 100 | < 250 | no rub out | very good | 0.04 | very good |
| 3 | Pigment Red 112 | 45 | very good | < 180 | < 350 | no rub out | very good | 0.11 | very good |
| 4 | Pigment Red 112 | 45 | very good | < 180 | < 350 | no rub out | very good | 0.68 | very good |
| 5 | Pigment Blue 015:3 | 40 | very good | < 100 | < 180 | no rub out | very good | 0.19 | very good |
| 6 | Pigment Black 007 | 33 | very good | < 50 | < 100 | no rub out | very good | 0.25 | very good |
| 7 | Pigment Violet 023 | 30 | very good | < 100 | < 250 | no rub out | very good | 0.03 | very good |
| 8 | Pigment Red 112 | 45 | very good | < 180 | < 350 | no rub out | very good | 0.29 | very good |
| 9 | Pigment | 40 | very | < 100 | < 180 | no rub out | very good | 0.28 | very good |

| | Blue 015:3 | | good | | | | | | |
|---|---|---|---|---|---|---|---|---|---|
| 10 | Pigment Black 007 | 33 | very good | < 50 | < 100 | no rub out | very good | 0.05 | very good |
| 11 | Pigment Violet 023 | 30 | very good | < 100 | < 250 | no rub out | very good | 0.03 | very good |
| Comp. 1 | Pigment Blue 015:3 | 40 | n.d. | n.d. | n.d. | n.d. | n.d. | not measurable | poor, set solid after < 1 day |
| Comp. 2 | Pigment Black 007 | 33 | 60% vs. ex. 6 | n.d. | n.d. | strong rub out | n.d. | 0.03 | poor, 2.5 Pa*s after storage |
| Comp. 3 | Pigment Violet 023 | 30 | 90% vs. ex. 2 | n.d. | n.d. | no rub out | poor | 0.04 | n.d. |

1. An aqueous pigment preparation, comprising
(A) at least one organic and/or inorganic pigment and/or filler
(B) at least one dispersant of the formula (I) or (II), or mixtures of dispersants of the formulas (I) and (II), 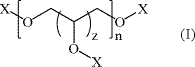 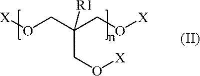
where
n is an integer greater than or equal to 1,
z is an integer greater than or equal to 1,
R1 is an aliphatic, linear or branched hydrocarbon radical having 1 to 10 carbon atoms or a hydrogen atom or the structural unit —O—X or the structural unit —CH₂—O—X,
and structural unit X corresponds to the formula (III) 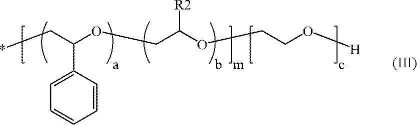
in which
a is an integer from 1 to 10,
b is an integer from 0 to 10,
c is an integer from 1 to 50,
m is 1 or 2; and
R2 is an aliphatic, linear or branched hydrocarbon radical having 1 to 10 carbon atoms,
and wherein 99% ofthe particles in component (A) have a particle size of < 500 nm.

2. The pigment preparation as claimed in claim 1, further comprising
(C) wetting agents,
(D) and/or further surfactants and/or dispersants,
(E) and/or one or more organic solvents and/or one or more hydrotropic substances and/or mixtures thereof,
(F) and/or further additives customary for the production of aqueous pigment dispersions, and
(G) optionally water.

3. The pigment preparation as claimed in claim 1 2, comprising 5% to 80% by weight of component (A).

4. The pigment preparation as claimed in claim 1, comprising 0.1 % to 30% by weight of component (B).

5. The pigment preparation as claimed in claim 2, comprising components (A) to (G):
(A) 5% to 80% by weight,
(B) 0.1% to 30% by weight,
(C) 0% to 10% by weight,
(D) 0% to 20% by weight,
(E) 0% to 30% by weight,
(F) 0% to 20% by weight,
(G) remainder water,
in each case based on the total weight (100% by weight) of the pigment preparation.

6. The pigment preparation as claimed in claim 2, comprising components (A) to (G):
(A) 10% to 70% by weight,
(B) 2% to 20% by weight,
(C) 0.1% to 5% by weight,
(D) 1% to 10% by weight,
(E) 5% to 20% by weight,
(F) 0.1% to 5% by weight,
(G) remainder water,
in each case based on the total weight (100% by weight) of the pigment preparation.

7. The pigment preparation as claimed in claim 1, wherein the organic pigment in component (A) is selected from the group consisting of a monoazo pigment, disazo pigment, laked azo pigment, β-naphthol pigment, naphthol AS pigment, benzimidazolone pigment, disazo condensation pigment, azo metal complex pigment or a polycyclic pigment from the group of the phthalocyanine pigments, quinacridone pigments, perylene pigments, perinone pigments, thioindigo pigments, anthanthrone pigments, anthraquinone pigments, flavanthrone pigments, indanthrone pigments, isoviolanthrone pigments, pyranthrone pigments, dioxazine pigments, quinophthalone pigments, isoindolinone pigments, isoindoline pigments, and diketopyrrolopyrrole pigments, or is a carbon black.

8. The pigment preparation as claimed in claim 1, wherein structural units (I) and (II) of component (B) are reaction products of alkoxylatable trihydric or polyhydric polyols, preferably diglycerol, erythritol, glycerol, pentaerythritol, polyglycerols, sorbitol, trimethylolpropane or xylitol.

9. The pigment preparation as claimed in claim 1, wherein the pigment preparation has a viscosity of less than 1.0 Pa*s.

10. The pigment preparation as claimed in claim 1, wherein 95% of the pigment particles have a particle size of less than 500 nm.

11. (canceled)

12. The pigment preparation as claimed in claim 1, wherein the average particle size is less than 200 nm.

13. The pigment preparation as claimed in claim 1, wherein the average particle size is less than 150 nm.

14. A process for producing a pigment preparation comprising
(A) at least one organic and/or inorganic pigment and/or filler
(B) at least one dispersant of the formula (I) or (II), or mixtures of dispersants of the formulas (I) and (II), 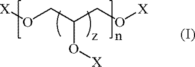 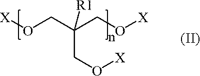
where
n is an integer greater than or equal to 1,
z is an integer greater than or equal to 1,
R1 is an aliphatic, linear or branched hydrocarbon radical having 1 to 10 carbon atoms or a hydrogen atom or the structural unit —O—X or the structural unit —CH₂—O—X,
and structural unit X corresponds to the formula (III) 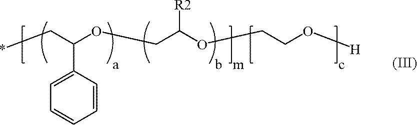
in which
a is an integer from 1 to 10,
b is an integer from 0 to 10,
c is an integer from 1 to 50,
m is 1 or 2; and
R2 is an aliphatic, linear or branched hydrocarbon radical having 1 to 10 carbon atoms,
and wherein 99% of the particles in component (A) have a particle size of < 500 nm, wherein component (A) in the form of powder, granules or aqueous press cake is dispersed in the presence of water (G) and also components (B) and optionally (C), (D), (E), and (F), and then admixed optionally with water (G) and also optionally with one or more of components (C), (D), (E), and (F), and the resulting aqueous pigment dispersion is optionally diluted with water (G).

15. The process for producing a pigment preparation as claimed in claim 14, wherein the powder, granules or aqueous press cake is dispersed using a stirred ball mill operated at a peripheral stirrer speed of over 10 m/s.

16. The process for producing a pigment preparation as claimed in claim 14, wherein the powder, granules or aqueous press cake is dispersed under the action of non-metallic grinding media having a diameter of less than or equal to 1.2 mm.

17. A natural or synthetic materials system comprising at least one aqueous pigment preparation according to claim 1.

18. An aqueous coating material, coating, emulsion/gloss paint, water-thinnable lacquer, glaze, varnishe, or wood protection system comprising at least one aqueous pigment preparation according to claim 1.

19. An ink for writing utensils, colored pencil leads, fibertip pens, fineliners, felt pens, gel rollers, text markers, and whiteboard markers comprising at least one aqueous pigment preparation according to claim 1.

20. A process for the production of inks, printing inks, inkjet inks, microemulsion inks, UV-curable inks, and also in those inks that function according to the hot-melt process, color filters, electronic inks, and electronic paper comprising the step of adding at least one aqueous pigment preparation according to claim 1 to the inks, printing inks, inkjet inks, microemulsion inks, UV-curable inks, and also in those inks that function according to the hot-melt process, color filters, electronic inks, and electronic paper.

21. A process for the production of electrophotographic toners and developers, one- or two-component powder toners, magnetic toners, liquid toners, latex toners, polymerization toners, and also specialty toners comprising the step of adding at least one aqueous pigment preparation according to claim 1 to the electrophotographic toners and developers, one- or two-component powder toners, magnetic toners, liquid toners, latex toners, polymerization toners, and also specialty toners.

22. A process for the pigmentation of natural and synthetic fiber materials, insulating materials, glass wool, sausage casings, seeds, fertilizers, glass, glass bottles, plaster, cement, wood stains, waxes, paraffins, drawing inks, pastes for ballpoint pens, chalks, washing and cleaning agents, shoe-care agents, latex products, abrasives, in spin dyeing of viscose, and plastics comprising the step of adding at least one aqueous pigment preparation according to claim 1 to the natural and synthetic fiber materials, insulating materials, glass wool, sausage casings, seeds, fertilizers, glass, glass bottles, plaster, cement, wood stains, waxes, paraffins, drawing inks, pastes for ballpoint pens, chalks, washing and cleaning agents, shoe-care agents, latex products, abrasives, in spin dyeing of viscose, and plastics.
